(19) United States
(12) Patent Application Publication
(10) Pub. No.: US 2008/0320017 A1
(43) Pub. Date: Dec. 25, 2008

(54) DETERMINING THE STRUCTURE OF RELATIONS AND CONTENT OF TUPLES FROM XML SCHEMA COMPONENTS

(75) Inventors: George Andrei Mihaila, Yorktown Heights, NY (US); Dung K. Nguyen, San Jose, CA (US); Mayank Pradhan, Santa Clara, CA (US)

Correspondence Address: IBM ST-SVL;SAWYER LAW GROUP LLP, 2465 E. Bayshore Road, Suite No. 406, PALO ALTO, CA, 94303, US

(73) Assignee: International Business Machines Corporation, Armonk, NY (US)

(21) Appl. No.: 12/202,303

(22) Filed: Aug. 31, 2008

Related U.S. Application Data
(63) Continuation of application No. 11/232,585, filed on Sep. 21, 2005.

(51) Int. Cl. G06F 17/30

(52) U.S. Cl. 707/100; 707/E17.009

(57) ABSTRACT

A system for determining relationships between hierarchically structured schema components and their effects on and content of tuples, includes: analyzing the hierarchically structured schema with user-supplied mappings and finding elements or attributes mapped to a same relational table; determining relationships between the elements or attributes to be either a one-to-one relationship or a one-to-many relationship based on an information set in the hierarchically structured schema; recording the relationships; and processing a hierarchically structured document against the recorded relationships and generating tuples accordingly. The constructs of a hierarchically structured schema that may affect the cardinality between the attributes of a relation, and thus the contents of the tuples, are considered. A relationship between the hierarchically structured schema model and a relational model is established.

### CROSS-REFERENCE TO RELATED APPLICATIONS

Under 35 USC § 120, this application is a continuation application and claims the benefit of priority to U.S. patent application Ser. No. 11/232,585, filed Sep. 21, 2005, entitled “Determining the Structure of Relations and Content of Tuples From XML Schema Components”, all of which is incorporated herein by reference.

### FIELD OF THE INVENTION

The present invention relates to the storing of hierarchically structured data, and more particularly to the establishment of relationships between hierarchically structured schema components and their effects on relations and content of tuples.

### BACKGROUND OF THE INVENTION

eXtensible Markup Language (XML) schemas, are becoming increasingly popular as a means to describe XML data. But the XML, described by the XML schema, is still often stored in relational tables. Some conventional approaches decompose XML documents using various mapping schemes to the relational structures. However, these approaches do not take into consideration how the components of the XML schema, as defined by W3C, can be used to determine the structure of the relations and the contents of the tuples that can be generated. They use the XML schema as a mapping of an element or attribute in the XML document to a particular column of the relational table. They do not consider the various constructs of an XML schema that may affect the cardinality between the attributes of a relation, and therefore the contents of the tuples. As used in this specification, “structure of relations” refers to the cardinality between the attributes of the relation.

Accordingly, there exists a need for a method for determining relationships between the hierarchically structured schema components and their effects on the structure of relations and content of tuples. The present invention addresses such a need.

### SUMMARY OF THE INVENTION

A System for determining relationships between hierarchically structured schema components and their effects on structure of relations and content of tuples, includes: analyzing the hierarchically structured schema with user-defined mappings and finding elements and/or attributes mapped to a same relational table; determining relationships between the elements or attributes to be either a one-to-one relationship or a one-to-many relationship based on an information set in the hierarchically structured schema; recording the relationships; and processing a hierarchically structured document against the recorded relationships and generating tuples accordingly. The constructs of a hierarchically structured schema that may affect the cardinality between the attributes of a relation, and thus the contents of the tuples, are considered. A relationship between the hierarchically structured schema model and a relational model is established.

### BRIEF DESCRIPTION OF THE FIGURES

FIG. 1 illustrates an XML schema infoset model according to the XML schema specification by W3C.

FIG. 2 illustrates example schema represented as a tree of components.

FIG. 3 illustrates an embodiment of a method for providing relationships between hierarchically structured schema components and their effects on the structure of relations and content of tuples in accordance with the present invention.

FIG. 4 is a flowchart illustrating in more detail the determination of relationships in accordance with the present invention.

FIGS. 5 and 6 illustrate examples of hierarchically structured schema in the method in accordance with the present invention.

### DETAILED DESCRIPTION

The present invention provides a method for determining relationships between hierarchically structured schema components and their effects on the structure of relations and content of tuples. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

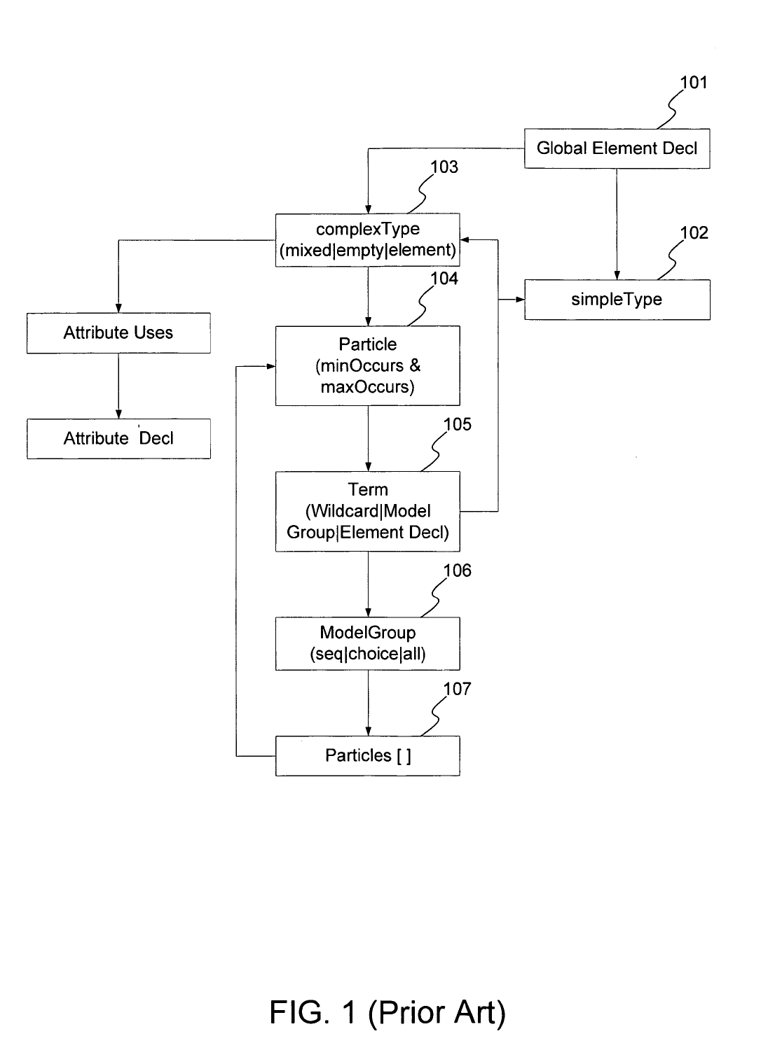

To more particularly describe the features of the present invention, please refer to FIGS. 1 through 6 in conjunction with the discussion below. Although the embodiment below are described in the context of XML, one of ordinary skill in the art will understand that the present invention may be applicable to other hierarchically structured schemas without departing from the spirit and scope of the present invention.

XML Schemas

FIG. 1 illustrates an XML schema infoset model according to the XML schema specification by W3C. In an XML schema, there can be many global element declarations 101. Each element declaration can be either a simpleType 102 or a complexType 103. If the element declaration is complexType 103, then it has a content model that can either be mixed, empty, or element. Further, the complexType 103 has a component called Particle 104, which enforces cardinality constraints through the minOccurs and maxOccurs properties on the content model. The component Particle 104 has another property called Term 105. Term 105 is an abstraction for WildCards, Element Declarations, and ModelGroups. A Term 105 can be any one of the above types. A Term of type Element Declaration can be a simpleType or complexType. The Term 105 can also be a ModelGroup 106. A ModelGroup 106 defines how the content will be laid out. A ModelGroup 106 can either be of type sequence, choice or all. For a sequence ModelGroup, items in the content model must appear in a sequence. For a choice ModelGroup, any one item within the content model can appear. For an all ModelGroup, the items of the content model can appear in any order. Each ModelGroup 106 contains many Particles 107. Each Particle 107 enforces a cardinality constraint, through its minOccurs and maxOccurs properties on the individual items of the content model. This allows an infinite depth recursion of ModelGroups, Particles and Element Declarations, which can describe any given XML schema.

Below is an example XML schema:

<?xml version=”1.0” encoding=”UTF-8”?><xs: schema
xmlns:xs=http://www.w3.org/2001/XMLSchema elementFormDefault=”
qualified” attributeFormDefault=”unqualified”>

<xs:element name=”PurchaseOrder”>

<xs:complexType>

<xs:sequence maxOccurs=”unbounded”>

<xs:element name=”LineItem”>

<xs:complexType>

<xs:sequence>

<xs:element name=”ITEMID”
type=”xs:string:/>
<xs:element name=”QTY”
type=”xs:integer”/>
<xs:element name=”PRICE”
type=“xs:float”/>

</xs:sequence>

</xs:complexType>

</xs:element>

</xs:sequence>
<xs:attribute name=”POID” type=”xs:string”/>

</xs:complexType>

</xs:element>

</xs:schema>

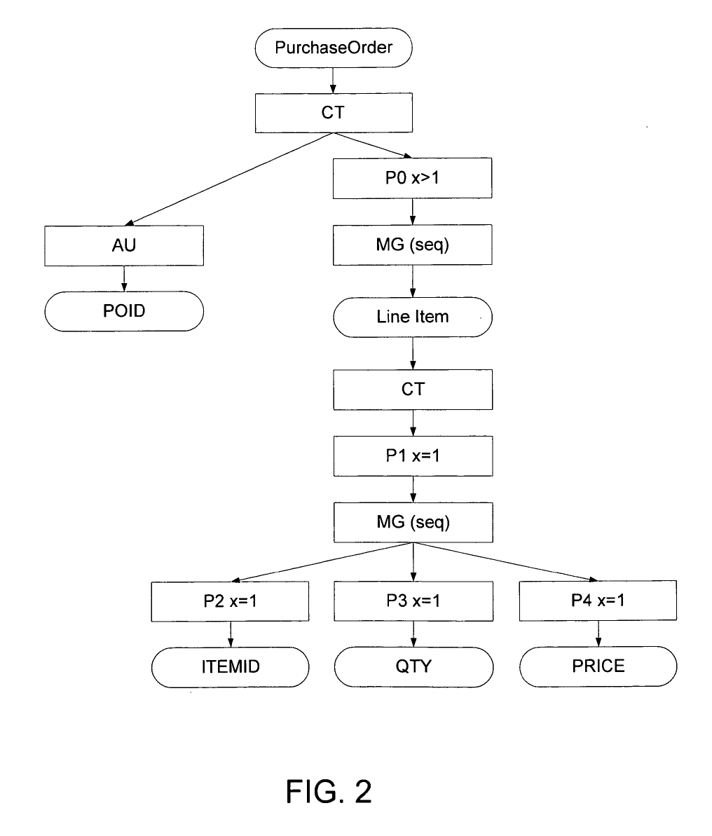

FIG. 2 illustrates the above example schema represented as a tree of components. The elliptical boxes are the element and attribute information items (e.g. POID is an attribute, and ITEMID is an element), and the rectangular boxes illustrate the various schema infoset components. Also, “CT” is complex type, and “AU” is attribute uses. “Pi” is particle #i, e.g. P0, P1, or P2. The property x of the component Particle is maxOccurs; the minOccurs property is represented as “n”. Here, P0 has x>1 since the sequence has maxOccurs=“unbounded”, as shown in the markup version of the XML schema. MG(seq) is a ModelGroup of type sequence, where MG(all) would be the ModelGroup of type all.

Relation Structure

The structure of a relation is a set of attributes that describes an entity, such as a purchase order or an employee. A relation is conventionally expressed as a set of functional dependencies between sets of attributes of the same relation. Besides the conventional approach, this invention takes another way of looking at the relationship between the sets of attributes of any relation or the structure of a relation is by looking at the cardinality of the attribute sets, in other words, the one-to-one or one-to-many relationships. Any use of the term “structure of a relation” in this specification refers to this approach.

Any relation r(R), where R is the number of attributes, can be divided into subsets, such that they have either a one-to-one relationship or a one-to-many relationship with each other. Furthermore, this invention applies an additional restriction on the structure of relation. If there exists attribute sets a, b, and c, such that a⊂R, b⊂R, and c⊂R and a∩b∩c=0, the relation r(R) can have a one-to-many relationship between a & b and a & c, identified as a<b and a<c, if and only if there exists b<c. This implies that a<c must be a transitively deduced relationship. Thus, a set cannot participate in a one-to-many relationship with two other sets without there being a one-to-many relationship between the other two. For this specification, when a relation is in a 1 normalized form (1NF) and satisfies the above condition, it is said to be in “shred normalized form”.

To illustrate the cardinality relationship between attribute sets of a relation, consider the following PurchaseOrder relation:

PurchaseOrder (POID, ITEMID, QTY, PRICE)

| POID | ITEMID | QTY | PRICE |
|---|---|---|---|
| 110-11 | I-1919 | 2 | 39.99 |
| 110-11 | I-1920 | 4 | 45.99 |
| 100-00 | I-1120 | 1 | 19.99 |
| 100-00 | I-1121 | 2 | 9.99 |

Note that for the same value of POID, there are more than one distinct set of ITEMID, QTY and PRICE. Therefore, there is a one-to-many relationship between the attribute POID and the set ITEMID, QTY and PRICE and since there is only a single one-to-many relationship involving POID, it is in shred normalized form.

An XML schema inherently contains one-to-one, one-to-many, and many-to-many relationships between elements. Since a relation, as shown above, can also be expressed as a set of one-to-one and one-to-many relationships, the method in accordance with the present invention establishes a relationship between the XML schema model and the relational model, as described below.

Relationships Between XML Schema Components and their Effects on the Structure of Relations and Content of Tuples

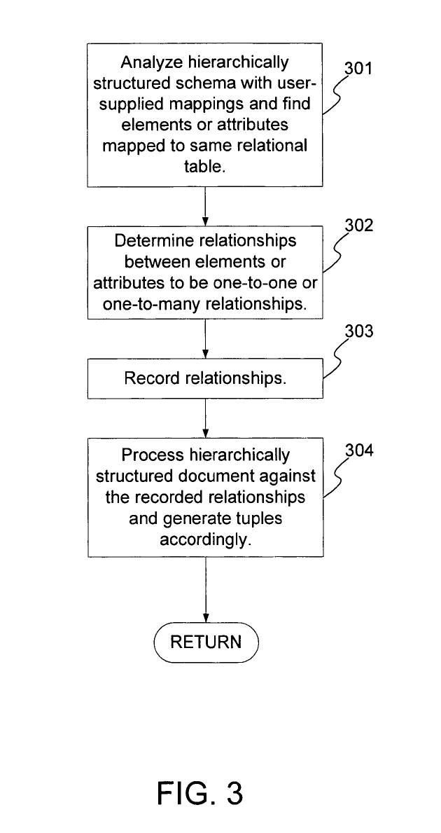

FIG. 3 illustrates an embodiment of a method for providing relationships between hierarchically structured schema components and their effects on the structure of relations and content of tuples in accordance with the present invention. First, the hierarchically structured schema, such as XML schema with user-supplied mappings is analyzed, elements attributes mapped to the same relational table are found, via step 301. The relationships between these elements or attributes are then determined to be either one-to-one or one-to-many relationships based on an information in the component model of the XML schema, via step 302. These relationships are then recorded, via step 303. A hierarchically structured document, such as an XML document, can then be processed against the recorded relationships, and tuples are generated accordingly, via step 304.

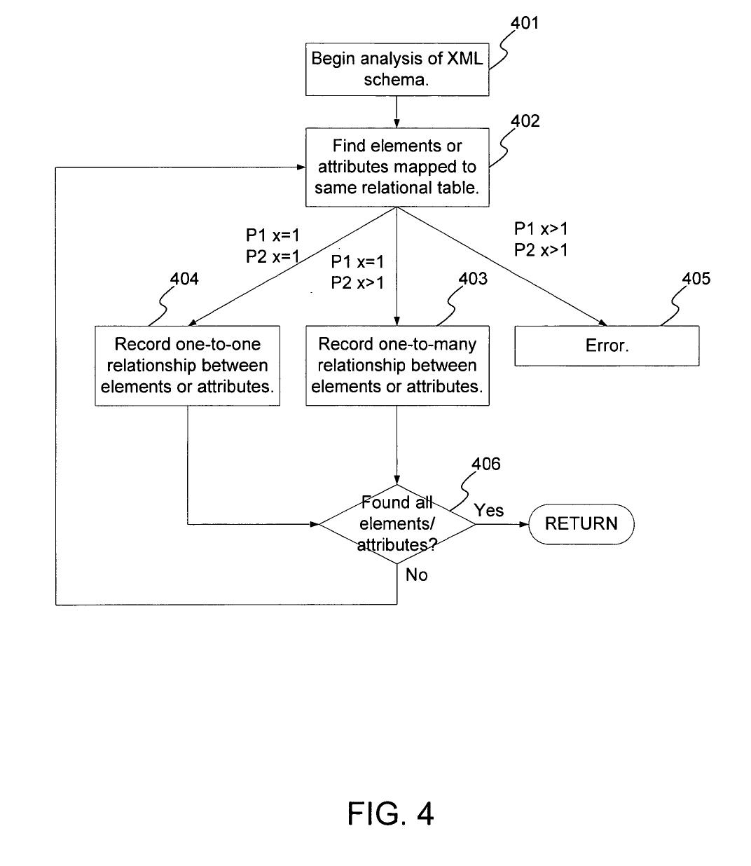

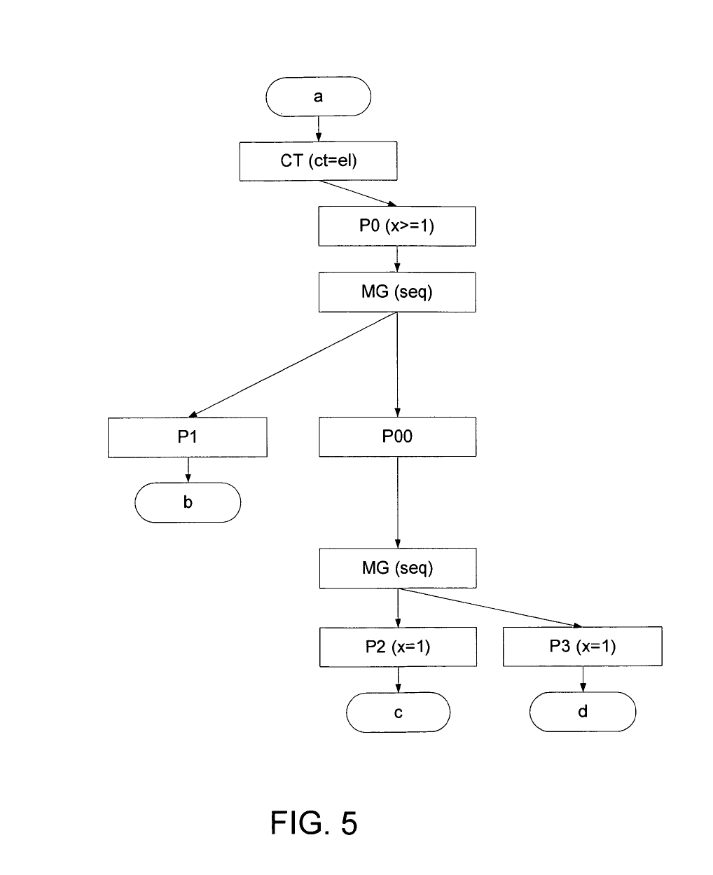

FIG. 4 is a flowchart illustrating in more detail the determination of relationships in accordance with the present invention. FIG. 5 illustrates an example schema. Referring to both FIGS. 4 and 5, first, the analysis of the XML schema user-supplied mappings is begun, via step 401. Elements and/or attributes mapped to the same relational table are found, via step 402. For each element or attribute, the maxOccurs property of the containing Particle (P1) and the particles of the containing model groups (P2) are used to determine its relationship with the other elements or attributes at the next level. In the example illustrated in FIG. 5, the contents of elements b, c, and d are mapped to the same relation but to different columns. The relation has attributes b, c, d. If P1(x=1) & P00(x=1) for every occurrence of b, there can be only one occurrence of the subset {c, d}. Similarly, there is a one-to-one relationship between c and the set {b, d}, and a one-to-one relationship between d and the set {b,c}.

If the maxOccurs properties for the Particles P1 and P00 are equal to 1 and greater than 1, respectively, then a one-to-many relationship between the elements is recorded, via step 403. R={b∴{c, d}}. Here, the set {c, d} can occur more than once for one occurrence of element b. Thus, there is a one-to-many relationship between the set {b} and the set {c, d}.

If the maxOccurs properties for both Particles P1 and P00 are greater than 1 and equal to 1, respectively, then a many-to-one relationship between the elements is recorded, via step 405. The resulting relation would look as follows: R={{c,d}<b}. This means that there might be one or more occurrences of the element b for a single occurrence of the set {c,d}. Thus, the one-to-many relationship is reversed, i.e., there is a one-to-many relationship between the set of elements {c, d} to the set {b}.

If the maxOccurs for both Particles P1 and P00 are greater than 1, then there is an error, via step 405, because this will not always produce a shred normalized relation.

Steps 402 through 405 are repeated until all elements mapped to the same relational table are found, via step 406. In this embodiment, the relationships are recorded in a data structure.

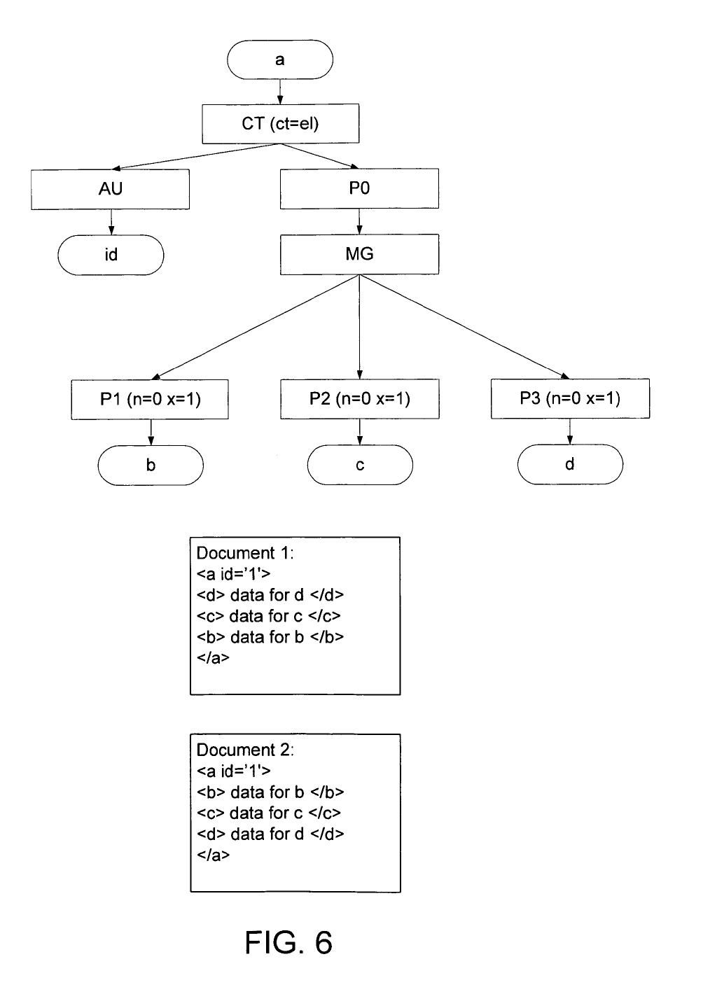

As illustrated above, Particles affect the structure of a relation. In addition, ModelGroups also have an effect. Unlike Particles, a ModelGroup affects the content of the tuples that are generated. Because ModelGroups in an XML schema describe the layout of the underlying elements that are mapped to the columns of the same relation, they have a direct impact on what is produced as a tuple. For example, while a ModelGroup of type sequence specifies the order in which elements should appear in the XML document, a ModelGroup of type all allows for the elements to appear in any order. This simple change, in combination with the value of maxOccurs, can cause a significant difference in the tuples that are generated. To illustrate this, consider the example XML schema shown in FIG. 6.

First, consider the example where P0 has maxOccurs>1 and the ModelGroup is of type sequence. Consider also the two XML Documents 1 and 2, illustrated in FIG. 6. The elements in Document 1 do not appear to be in the order specified by the ModelGroup. The order according to the ModelGroup should be b-c-d. Thus, in accordance with the present invention, these are treated as three instances of the same ModelGroup, MG, with optional elements ‘b’ and ‘c’ absent in the first instance, ‘b’ and ‘d’ absent in the second instance, and ‘c’ and ‘d’ absent in the third instance. Because of this, when the elements ‘b’, ‘c’, and ‘d’ are mapped to different columns of the same relation, they produce three tuples as follows:

| id | b | c | d |
|---|---|---|---|
| 1 | — | — | data for d |
| 1 | — | data for c | — |
| 1 | data for b | — | — |

In Document 2, there is only one instance of MG, since the elements of the ModelGroup have appeared in the expected order. Therefore, only one tuple is generated, as follows:

| id | b | c | d |
|---|---|---|---|
| 1 | data for b | data for c | data for d |

Now, assume that MG is of type all, which means that P0 must have maxOccurs=1 to ensure determinism, according to the W3C specification. Since the order is not important for ModelGroups of type all, both Document 1 and Document 2 contain only one instance of MG. A change of the type to all thus would generate only one tuple from both documents, as follows:

| id | b | c | d |
|---|---|---|---|
| 1 | data for b | data for c | data for d |

Now, assume that MG is of type choice. Only one of the elements specified in the ModelGroup can appear for any instance of the ModelGroup. If MG was of type choice and P0 had maxOccurs>1, the resulting tuples for Document 1 and Document 2 would be the same since each instance of an element under the choice ModelGroup is an instance of the ModelGroup itself. Conceptually, this is equivalent to making three copies of the component model, whereby in each copy, the choice ModelGroup is replaced by a sequence ModelGroup with a single Particle P1, P2, or P3 under it in each copy. The appropriate component model is then used during decomposition, depending on which element appeared in the instance document. Therefore, to handle XML schemas that contain choice ModelGroups, during the analysis of the XML schema, before the determination of cardinality of relationships between attribute sets, the following step is added: where there is a choice ModelGroup with N particles in the XML schema, create N copies of the component model, where the choice ModelGroup is replaced by a sequence ModelGroup containing a single particle, each particle being different in each copy. This “cloning” process is repeated for each choice ModelGroup in the set of new copies of the component model until no choice model remains. The final set of copies of the component model are used in the step of determining relationship cardinality. Likewise, in determining whether a XML schema with choice ModelGroups satisfied shred normal form, the final set of clones, rather than the original XML schema, is used.

The following result would be produced for both documents, as follows:

| id | b | c | d |
|---|---|---|---|
| 1 | — | — | data for d |
| 1 | — | data for c | — |
| 1 | data for b | — | — |

Note that we do not consider a mapping where MG is of type choice and Particles P1, P2 and P3 have maxOccurs>1, to be an instance of illegal many-to-many mapping. This is because of the fact that the type of the model group enforces that elements b, c or d can appear only in a mutually exclusive manner for any instance of the choice ModelGroup. The following relation is inferred for such a mapping:

If MG=choicêP1(x>1)̂P2(x>1)̂P3(x>1) then
R={id ∴ {{b}|{c}|{d}}}

It can be seen that the property of shred normalized form is still retained for the relation R, shown above, due to the content model enforced by the type of the model group. For any instance of the choice ModelGroup there will only be a single one-to-many relationship i.e. id ∴ b or id ∴ c or id ∴ d. It can also be seen that this is an exception, where a seemingly many-to-many relationship is permitted. A legal many-to-many mapping is therefore now defined as follows: a mapping is considered to be a legal many-to-many relationship between two information items if and only if the lowest common ancestor model group of the two items is a choice model group.

While in the above example, with choice model group, elements b, c and d are mapped to different columns of the same table, it would also be desirable, in some customer scenarios, that elements b, c and d be mapped to the same column of the same table.

The semantics implied by this approach, for such a mapping would mean that information items, that appear for a particular that instance of the choice ModelGroup, will be applied to the tuple. For the above example, consider now that the elements b, c and d are mapped to the same table-column pair. For both documents Document 1 and Document 2, the following set of tuples will be created:

| id | choicedata |
|---|---|
| 1 | data for d |
| 1 | data for c |
| 1 | data for b |

Note that the two items mapped to the same table-column pair need not be direct children of the choice model group. An “effective choice model group” is computed for this purpose. Any two items that are mapped to the same table-column pair are considered to be part of the same effective choice model group if and only if the lowest common ancestor ModelGroup of the two items is a choice ModelGroup. Any pair of items that are mapped to the same table-column and belong to the same effective choice model group will produce tuples with the semantics as shown above.

Now consider for the above example that elements b, c and d are mapped to different table-column pairs, tab1.col2, tab2.col2 and tab3.col2 respectively. Also the attribute id is mapped to tab1.col1, tab2.col1 and tab3.col1. As explained above, for Document 1 there are three instances of the choice ModelGroup. However, for the first instance of choice ModelGroup, the elements b and c are absent, for the second instance of the choice ModelGroup elements b and d are absent and for the third instance elements c and d are absent. For absent items, nulls are written in the cells of the tuples that they are mapped to. Therefore, this would produce the following tuples for each of the tables

TABLE 1

| col1 | col2 |
|---|---|
| 1 | — |
| 1 | — |
| 1 | data for b |

TABLE 2

| col1 | col2 |
|---|---|
| 1 | — |
| 1 | data for c |
| 1 | — |

TABLE 3

| col1 | col2 |
|---|---|
| 1 | data for d |
| 1 | — |
| 1 | — |

Clearly, this is not a desirable result since extraneous rows are produced that contain no information. To make matters worse suppose that element c and d never appeared in an instance document, but there were 100 occurrences of element b. This would then produce 100 rows in each table. While in tab1, the column col2 would have information related to each occurrence of element b, but in tables tab2 and tab3, column col2 will contain null for all 100 rows.

To overcome the problem of extraneous rows, the following existential condition is applied to choice ModelGroups: a tuple is created for an item that is directly or indirectly contained in a choice ModelGroup, if and only if, the choice ModelGroup has occurred in response to the occurrence of an element, in the instance document, that is a descendant of the choice ModelGroup, and is either the mapped item itself or an ancestor of the mapped item.

The implication of this rule on the above example would be the following set of tuples for each of the tables:

TABLE 1

| col1 | col2 |
|---|---|
| 1 | data for b |

TABLE 2

| col1 | col2 |
|---|---|
| 1 | data for c |

TABLE 3

| col1 | col2 |
|---|---|
| 1 | data for d |

Note that now the tuples are produced only when the instance of choice model group occurs for the items mapped in that tuple.

There is an additional subtlety that occurs for the following instance document:

<a id=‘1’>

</a>

In such a case, no rows are produced in any of the tables as this would once again produce extraneous tuples in each of the rows.

As illustrated above, the method in accordance with the present invention uses the type of the ModelGroup and the maxOccurs property of the enclosing Particle to determine the content and number of tuples.

Optionally, to simplify implementation, the following rules can be applied:

(1) There can be any number of entities involved in a relation, only one-to-one or one-to-many relationships are allowed between them to ensure that tuples that are generated are in shred normalized form. A pair of a set of attributes can be involved in a one-to-many relationship, such that the set of attributes that has a cardinality of one in the relationship will be a level above the set of attributes that forms the many parts of the one-to-many relationship. There can be any number of such levels, since a relation may have any number of entities.

(2) There can be no illegal many-to-many relationships and at most a single one-to-many relationship at any level. Otherwise, it is considered an error. A many-to-many relationship between two elements/attributes is legal only if the lowest common ancestor model group of both element/attribute is a choice model group. In other words, if there are three entities x, y, and z, such that x has a one-to-many relationship with y and a one-to-many relationship with z, then it is possible for only one of them to exist at the same level. But, if x has a one-to-one relationship with z, then the relationships between x and y, and x and z, can exist at the same level.

(3) The end of the topmost component that identifies the beginning of a repetitive subset, e.g. Particle or ModelGroup, marks the end of all possible tuples. The beginning of any inner repetitive subset triggers initiation of a new tuple if it is not the first repetition within its parent repetitive set.

A method for determining relationships between hierarchically structured schema components and their effects on structure of relations and content of tuples, includes: analyzing the hierarchically structured schema with user-supplied mappings, making copies of the component model in which a choice ModelGroup with N particles is replaced by a sequence ModelGroup with one particle under the ModelGroup, each particle being different in each copy; and in each copy of the component model, finding elements mapped to a same relational table; determining relationships between the elements to be either a one-to-one relationship or a one-to-many relationship based on the information set in the hierarchically structured schema; recording the relationships; and processing a hierarchically structured document against the recorded relationships and generating tuples accordingly. The constructs of a hierarchically structured schema that may affect the cardinality between the attributes of a relation, and thus the contents of the tuples, are considered. A relationship between the hierarchically structured schema model and a relational model is established.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A system, comprising:
a hierarchically structured schema comprising a plurality of elements or attributes; and
a data structure comprising relationships between the elements or attributes of the hierarchically structured schema, wherein the relationships between the elements or attributes comprises one-to-one relationships or one-to-many relationships based on an information set in the hierarchically structured schema, wherein a hierarchically structured document can be processed against the relationships and tuples are generated accordingly.

2. The system of claim 1, wherein particle components of the elements or attributes in a relationship each comprises a maxOccurs property,
wherein the involved Particle of an element comprises any particle on a path from the element or attribute to the lowest common ancestor of the two elements or attributes whose relationship is being determined,
wherein if each maxOccurs property equals one, then a one-to-one relationship between the elements or attributes is recorded in the data structure,
wherein if one element or attribute has all involved particles with maxOccurs equal to one, and other element or attribute has one or more involved particles with maxOccurs greater than one, then a one-to-many relationship between the elements or attributes is recorded in the data structure.

3. The system of claim 2, wherein if both elements or attributes comprise an involved particle with each maxOccurs property greater than one and there is an illegal many-to-many relationship, then an error is indicated.

4. The system of claim 1, further comprising the tuples, wherein a structure of relations is based upon the recorded relationships, and content of the tuples is based upon a type of a ModelGroup and maxOccurs.

5. The system of claim 4, wherein the type of the ModelGroup comprises a sequence, a choice, or all.
